(19) United States
(12) Patent Application Publication
(10) Pub. No.: US 2010/0097042 A1
(43) Pub. Date: Apr. 22, 2010

(54) LOW DROPOUT REGULATOR HAVING A CURRENT-LIMITING MECHANISM

(76) Inventor: Hsien-Cheng Hsieh, Hsinchu City (TW)

Correspondence Address: NORTH AMERICA INTELLECTUAL PROPERTY CORPORATION, P.O. BOX 506, MERRIFIELD, VA, 22116, US

(21) Appl. No.: 12/273,554

(22) Filed: Nov. 19, 2008

(30) Foreign Application Priority Data
Oct. 20, 2008 (TW) 097140185

(51) Int. Cl. G05F 1/00

(52) U.S. Cl. 323/282

(57) ABSTRACT

A low dropout regulator having a current-limiting mechanism is disclosed. The regulator includes a sensing resistor, an error amplifier, and first through fourth transistors. The first transistor generates an output voltage according to an input voltage and a current control signal. The sensing resistor is employed to generate a sense voltage based on the current flowing through the fourth transistor so as to control the second transistor for generating an internal voltage. The third transistor controls the current control signal based on a voltage divided from the internal voltage. The channel width/length ratio of the first transistor is greater than that of the fourth transistor. When the third transistor is turned off, the error amplifier adjusts the voltage of the current control signal according to a voltage divided from the output voltage; when the third transistor is turned on, the voltage of the current control signal is not adjusted.

### BACKGROUND OF THE INVENTION

1. Field of the Invention

The present invention relates to a low dropout regulator, and more particularly, to a low dropout regulator having a current-limiting mechanism.

2. Description of the Prior Art

Please refer to FIG. 1, which is a circuit diagram schematically showing a prior-art low dropout regulator. As shown in FIG. 1, the low dropout regulator 100 comprises a sensing resistor Rsen, a reference resistor Rref, a feedback voltage-dividing unit 195, a reference current source 190, a comparator 120, an error amplifier 110, a first transistor 115, and a second transistor 125. The low dropout regulator 100 is employed to convert an input voltage Vin to a stable output voltage Vout forwarded to a load 101.

In general, the feedback voltage-dividing unit 195 comprises two voltage-dividing resistors Rfb1, Rfb2 and functions to provide a divided voltage Vdiv of the output voltage Vout furnished to the error amplifier 110. The reference resistor Rref is utilized for providing a first reference voltage Vref1 based on the input voltage Vin and the reference current Iref of the reference current source 190. The sensing resistor Rsen is utilized for generating a sense voltage Vsen based on an output current Iout flowing through the first transistor 115. The comparator 120 compares the sense voltage Vsen with the first reference voltage Vref1 so as to generate a gate signal Sgx furnished to the control end (gate) of the second transistor 125. The error amplifier 110 performs an error amplification operation on the divided voltage Vdiv based on a second reference voltage Vref2 for generating a current control signal Sct forwarded to the control end of the first transistor 115. The first transistor 115 controls the output current Iout according to the current control signal Sct, and therefore controls the output voltage Vout. In the operation of the low dropout regulator 100, when the output current Iout is higher than an upper-limit current, the comparator 120 outputs the gate signal Sgx having a high-level voltage for turning on the second transistor 125; in turn, the current control signal Sct is pulled down to a low-level voltage through the second transistor 125. Accordingly, the first transistor 115 is able to reduce the output current Iout to be less than the upper-limit current based on the current control signal Sct having the low-level voltage.

However, the internal voltage drop, i.e. a voltage difference between the input voltage Vin and the output voltage Vout, increases following an increase of the output current Iout flowing through the sensing resistor Rsen in that the sensing resistor Rsen is connected with the first transistor 115 in series. For that reason, the low dropout regulator 100 is likely to incur high internal power consumption and high chip temperature, and therefore results in a shortcoming of low circuit working efficiency. Besides, the low dropout regulator 100 has another shortcoming of high production cost caused by a significant chip area required for disposing the comparator 120.

### SUMMARY OF THE INVENTION

In accordance with an embodiment of the present invention, a low dropout regulator having a current-limiting mechanism is disclosed. The low dropout regulator comprises a first transistor, a second transistor, a sensing resistor, a third transistor, a fourth transistor and an error amplifier.

The first transistor comprises a first end for receiving an input voltage, a second end for outputting an output voltage and an output current, and a control end for receiving a current control signal. The first transistor is employed to control the output current based on the current control signal. The second transistor comprises a first end for receiving the input voltage, a second end for outputting an internal voltage, and a control end. The sensing resistor is electrically coupled between the first end and the control end of the second transistor. The sensing resistor is utilized for generating a sense voltage furnished to the control end of the second transistor. The third transistor comprises a first end electrically coupled to the control end of the first transistor, a second end electrically coupled to a ground, and a control end for receiving a divided voltage of the internal voltage. The fourth transistor comprises a first end electrically coupled to the sensing resistor, a second end electrically coupled to the second end of the first transistor, and a control end electrically coupled to the control end of the first transistor. The error amplifier comprises a positive input end for receiving a reference voltage, a negative input end for receiving a divided voltage of the output voltage, and an output end electrically coupled to the control end of the first transistor. The error amplifier is employed to generate the current control signal based on the reference voltage and the divided voltage of the output voltage.

In accordance with another embodiment of the present invention, a low dropout regulator having a current-limiting mechanism is disclosed. The low dropout regulator comprises a first transistor, a second transistor, a sensing resistor, a third transistor, a fourth transistor, a fifth transistor, a sixth transistor and an error amplifier.

The first transistor comprises a first end for receiving an input voltage, a second end for outputting an output voltage and an output current, and a control end for receiving a current control signal. The first transistor is employed to control the output current based on the current control signal. The second transistor comprises a first end for receiving the input voltage, a second end for outputting an internal voltage, and a control end. The sensing resistor is electrically coupled between the first end and the control end of the second transistor. The sensing resistor is utilized for generating a sense voltage furnished to the control end of the second transistor. The third transistor comprises a first end for receiving a power voltage or the input voltage, a second end, and a control end for receiving a divided voltage of the internal voltage. The fourth transistor comprises a first end electrically coupled to the second end of the third transistor, a second end electrically coupled to a ground, and a control end electrically coupled to the control end of the third transistor. The fifth transistor comprises a first end for receiving the power voltage or the input voltage, a second end electrically coupled to the control end of the first transistor, and a control end electrically coupled to the second end of the third transistor. The sixth transistor comprises a first end electrically coupled to the sensing resistor, a second end electrically coupled to the second end of the first transistor, and a control end electrically coupled to the control end of the first transistor. The error amplifier comprises a positive input end for receiving a divided voltage of the output voltage, a negative input end for receiving a reference voltage, and an output end electrically coupled to the control end of the first transistor. The error amplifier is employed to generate the current control signal based on the reference voltage and the divided voltage of the output voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a circuit diagram schematically showing a prior-art low dropout regulator.

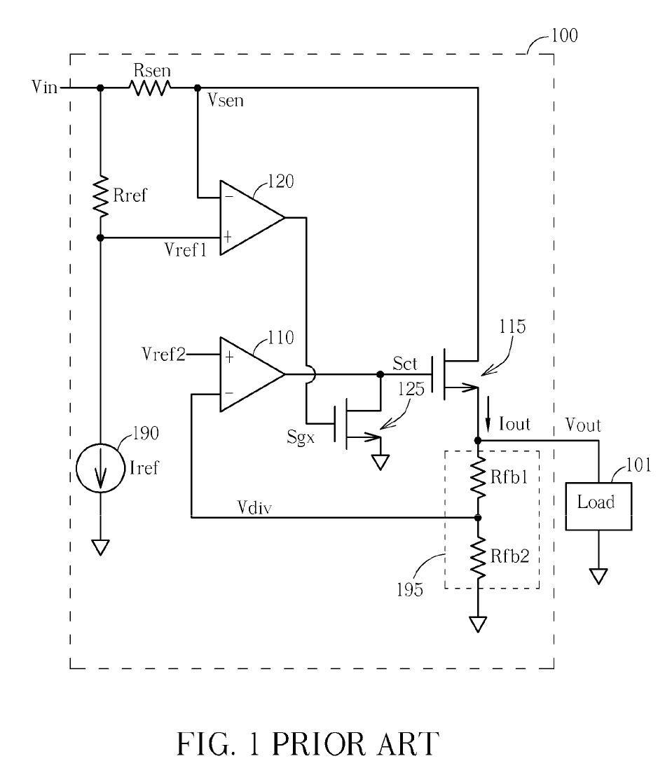

FIG. 2 is a circuit diagram schematically showing a low dropout regulator in accordance with a first embodiment of the present invention.

FIG. 3 is a circuit diagram schematically showing a low dropout regulator in accordance with a second embodiment of the present invention.

FIG. 4 is a circuit diagram schematically showing a low dropout regulator in accordance with a third embodiment of the present invention.

FIG. 5 is a circuit diagram schematically showing a low dropout regulator in accordance with a fourth embodiment of the present invention.

### DETAILED DESCRIPTION

Hereinafter, preferred embodiments of the present invention will be described in detail with reference to the accompanying drawings. Here, it is to be noted that the present invention is not limited thereto.

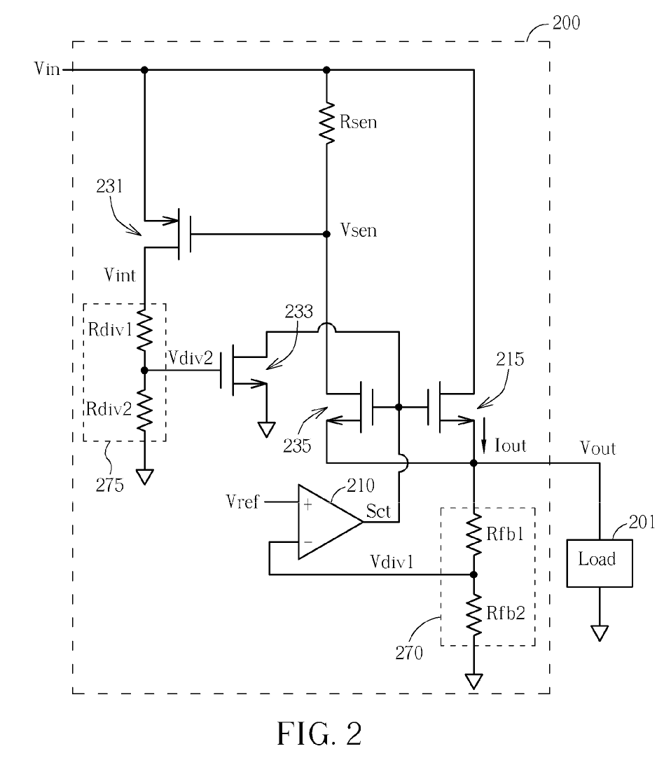

Please refer to FIG. 2, which is a circuit diagram schematically showing a low dropout regulator in accordance with a first embodiment of the present invention. As shown in FIG. 2, the low dropout regulator 200 comprises a sensing resistor Rsen, a first voltage-dividing unit 270, a second voltage-dividing unit 275, a first transistor 215, a second transistor 231, a third transistor 233, a fourth transistor 235, and an error amplifier 210. The first transistor 215, the third transistor 233 and the fourth transistor 235 are N-type metal oxide semiconductor (MOS) field effect transistors or N-type junction field effect transistors. The channel width/length ratio of the first transistor 215 is much greater than that of the fourth transistor 235. The second transistor 231 is a P-type MOS field effect transistor or a P-type junction field effect transistor. The low dropout regulator 200 is employed to convert an input voltage Vin to a stable output voltage Vout forwarded to a load 201.

The first transistor 215 comprises a first end for receiving the input voltage Vin, a second end for outputting the output voltage Vout and an output current Iout, and a control end for receiving a current control signal Sct. The first transistor 215 controls the output current Iout according to the current control signal Sct, and therefore controls the output voltage Vout. The first voltage-dividing unit 270 comprises two voltage-dividing resistors Rfb1, Rfb2 and functions to provide a first divided voltage Vdiv1 of the output voltage Vout furnished to the error amplifier 210. The second transistor 231 comprises a first end for receiving the input voltage Vin, a second end for outputting an internal voltage Vint, and a control end. The sensing resistor Rsen is coupled between the first end and the control end of the second transistor 231. The sensing resistor Rsen is utilized for generating a sense voltage Vsen based on a current flowing through the fourth transistor 235. The sense voltage Vsen is furnished to the control end of the second transistor 231. Accordingly, the second transistor 231 is utilized to control the internal voltage Vint based on the sense voltage Vsen received by the control end.

The second voltage-dividing unit 275 comprises two voltage-dividing resistors Rdiv1, Rdiv2 and functions to provide a second divided voltage Vdiv2 of the internal voltage Vint furnished to the third transistor 233. The third transistor 233 comprises a first end coupled to the control end of the first transistor 215, a second end coupled to a ground, and a control end coupled to the second voltage-dividing unit 275 for receiving the second divided voltage Vdiv2. The fourth transistor 235 comprises a first end coupled to the sensing resistor Rsen, a second end coupled to the second end of the first transistor 215, and a control end coupled to the control end of the first transistor 215. The first transistor 215 and the fourth transistor 235 are coupled to form a current mirror, and therefore the current flowing through the sensing resistor Rsen is proportional to the output current Iout. Since the channel width/length ratio of the first transistor 215 is much greater than that of the fourth transistor 235, the current flowing through the sensing resistor Rsen is substantially much smaller than the output current Iout. The error amplifier 210 comprises a positive input end for receiving a reference voltage Vref, a negative input end coupled to the first voltage-dividing unit 270 for receiving the first divided voltage Vdiv1, and an output end coupled to the control end of the first transistor 215. The error amplifier 210 performs an error amplification operation on the first divided voltage Vdiv1 based on the reference voltage Vref for generating the current control signal Sct forwarded to the control end of the first transistor 215.

In the operation of the low dropout regulator 200, the first voltage-dividing unit 270 and the error amplifier 210 are employed to provide a negative feedback mechanism for controlling the first transistor 215 so as to stabilize the output voltage Vout. Besides, the sensing resistor Rsen, the second voltage-dividing unit 275, the second transistor 231, the third transistor 233 and the fourth transistor 235 are employed to provide a current-limiting mechanism for controlling the first transistor 215 so as to limit the output current Iout to be lower than an upper-limit current. The circuit operation of the low dropout regulator 200 is detailed as the followings.

When the output current Iout is less than the upper-limit current, the second transistor 231 is turned off by the sense voltage Vsen, and therefore both the internal voltage Vint and the second divided voltage Vdiv2 are pulled down to ground voltage level. In turn, the third transistor 233 is turned off by the second divided voltage Vdiv2 having ground voltage level. Under such situation, the error amplifier 210 is utilized to adjust the voltage of the current control signal Sct by performing an error amplification operation on the first divided voltage Vdiv1; meanwhile, the first transistor 215 is used to control the output current Iout according to the current control signal Sct adjusted, and therefore controls the output voltage Vout. The circuit operation of the negative feedback mechanism, regarding the error amplifier 210 and the first voltage-dividing unit 270, is well known to those skilled in the art, and for the sake of brevity, further discussion thereof is omitted.

When the output current Iout is greater than the upper-limit current, the second transistor 231 is turned on by the sense voltage Vsen, and therefore the internal voltage Vint is switched to be a high-level voltage; in turn, the second divided voltage Vdiv2 is pulled up for turning on the third transistor 233. When the third transistor 233 is turned on, the current control signal Sct is pulled down to ground voltage level; meanwhile, the first transistor 215 is able to reduce the output current Iout to be less than the upper-limit current based on the current control signal Sct having ground voltage level. In other words, when the output current Iout is greater than the upper-limit current, the voltage of the current control signal Sct cannot be adjusted by the error amplifier 210.

To sum up, in the operation of the low dropout regulator 200, the voltage drop across the sensing resistor Rsen is excluded from the voltage difference between the input voltage Vin and the output voltage Vout so that the voltage difference between the input and output voltages can be lessened. Furthermore, the current flowing through the sensing resistor Rsen is much smaller than the output current Iout, and therefore both the internal power consumption and the chip temperature can be reduced for improving circuit working efficiency. Besides, compared with the prior-art low dropout regulator 100, the comparator 120 and the reference current source 190 are not required in the low dropout regulator 200, and for that reason, the chip area can be reduced significantly for achieving low production cost.

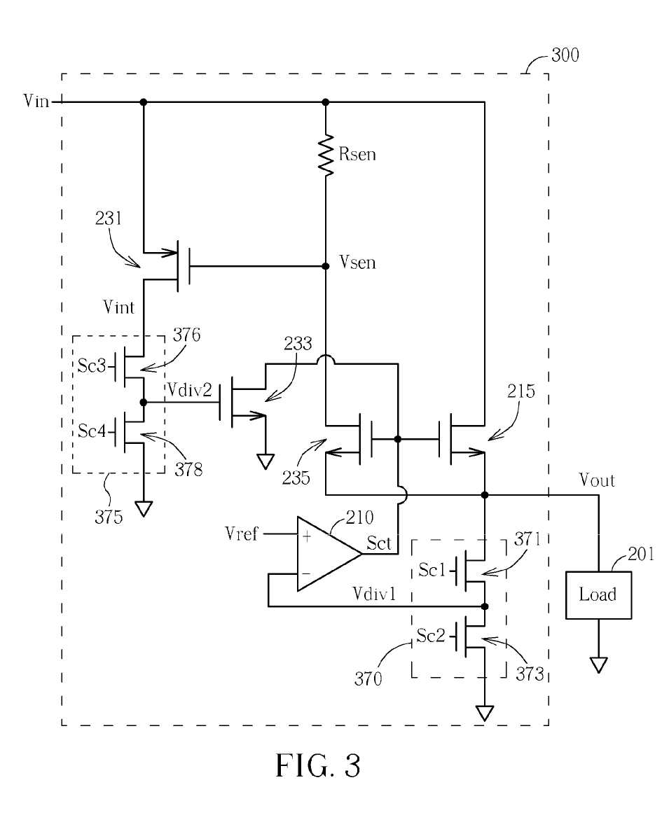

Please refer to FIG. 3, which is a circuit diagram schematically showing a low dropout regulator in accordance with a second embodiment of the present invention. As shown in FIG. 3, the circuit structure of the low dropout regulator 300 is similar to that of the low dropout regulator 200, differing in that the first voltage-dividing unit 270 is replaced with a first voltage-dividing unit 370 and the second voltage-dividing unit 275 is replaced with a second voltage-dividing unit 375. The first voltage-dividing unit 370 comprises a fifth transistor 371 and a sixth transistor 373. The fifth transistor 371 comprises a first end coupled to the second end of the first transistor 215, a second end coupled to the negative input end of the error amplifier 210, and a control end for receiving a first control signal Sc1. The first control signal Sc1 is employed to adjust the first channel resistance of the fifth transistor 371. The sixth transistor 373 comprises a first end coupled to the second end of the fifth transistor 371, a second end coupled to the ground, and a control end for receiving a second control signal Sc2. The second control signal Sc2 is employed to adjust the second channel resistance of the sixth transistor 373. The fifth transistor 371 and the sixth transistor 373 are MOS field effect transistors or junction field effect transistors.

The second voltage-dividing unit 375 comprises a seventh transistor 376 and an eighth transistor 378. The seventh transistor 376 comprises a first end coupled to the second end of the second transistor 231, a second end coupled to the control end of the third transistor 233, and a control end for receiving a third control signal Sc3. The third control signal Sc3 is employed to adjust the third channel resistance of the seventh transistor 376. The eighth transistor 378 comprises a first end coupled to the second end of the seventh transistor 376, a second end coupled to the ground, and a control end for receiving a fourth control signal Sc4. The fourth control signal Sc4 is employed to adjust the fourth channel resistance of the eighth transistor 378. The seventh transistor 376 and the eighth transistor 378 are MOS field effect transistors or junction field effect transistors.

Basically, both the first voltage-dividing unit 370 and the second voltage-dividing unit 375 are adjustable voltage dividers. The first voltage-dividing unit 370 performs a voltage dividing operation on the output voltage Vout for generating the first divided voltage Vdiv1 according to the adjusted first and second channel resistances. The second voltage-dividing unit 375 performs a voltage dividing operation on the internal voltage Vint for generating the second divided voltage Vdiv2 according to the adjusted third and fourth channel resistances.

In another embodiment, both the control ends of the fifth transistor 371 and the sixth transistor 373 are utilized for receiving same control signal; besides, the first channel resistance is determined by the channel width/length ratio of the fifth transistor 371 and the second channel resistance is determined by the channel width/length ratio of the sixth transistor 373. In other words, the dividing ratio of the first voltage-dividing unit 370 can be determined by the channel width/length ratios of the fifth transistor 371 and the sixth transistor 373. The channel width/length ratio of the fifth transistor 371 can be identical to or different from that of the sixth transistor 373. Similarly, both the control ends of the seventh transistor 376 and the eighth transistor 378 are utilized for receiving same control signal; besides, the third channel resistance is determined by the channel width/length ratio of the seventh transistor 376 and the fourth channel resistance is determined by the channel width/length ratio of the eighth transistor 378. In other words, the dividing ratio of the second voltage-dividing unit 375 can be determined by the channel width/length ratios of the seventh transistor 376 and the eighth transistor 378. The channel width/length ratio of the seventh transistor 376 can be identical to or different from that of the eighth transistor 378.

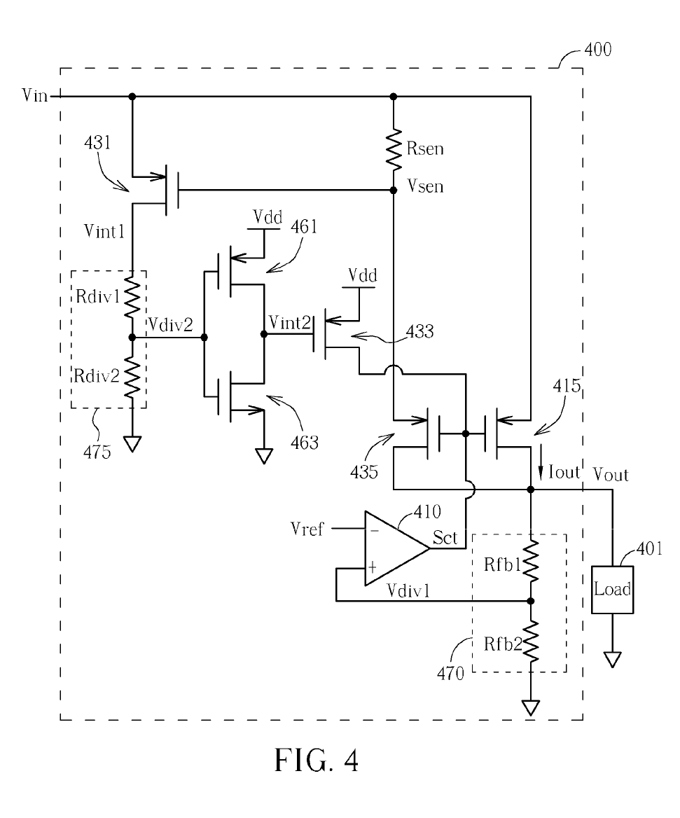

Please refer to FIG. 4, which is a circuit diagram schematically showing a low dropout regulator in accordance with a third embodiment of the present invention. As shown in FIG. 4, the low dropout regulator 400 comprises a sensing resistor Rsen, a first voltage-dividing unit 470, a second voltage-dividing unit 475, a first transistor 415, a second transistor 431, a third transistor 461, a fourth transistor 463, a fifth transistor 433, a sixth transistor 435, and an error amplifier 410. The first transistor 415, the second transistor 431, the third transistor 461, the fifth transistor 433 and the sixth transistor 435 are P-type MOS field effect transistors or P-type junction field effect transistors. The channel width/length ratio of the first transistor 415 is much greater than that of the sixth transistor 435. The fourth transistor 463 is an N-type MOS field effect transistor or an N-type junction field effect transistor. The low dropout regulator 400 is employed to convert an input voltage Vin to a stable output voltage Vout forwarded to a load 401.

The first transistor 415 comprises a first end for receiving the input voltage Vin, a second end for outputting the output voltage Vout and an output current Iout, and a control end for receiving a current control signal Sct. The first transistor 415 controls the output current Iout according to the current control signal Sct, and therefore controls the output voltage Vout. The first voltage-dividing unit 470 comprises two voltage-dividing resistors Rfb1, Rfb2 and functions to provide a first divided voltage Vdiv1 of the output voltage Vout furnished to the error amplifier 410. The second transistor 431 comprises a first end for receiving the input voltage Vin, a second end for outputting a first internal voltage Vint1, and a control end. The sensing resistor Rsen is coupled between the first end and the control end of the second transistor 431. The sensing resistor Rsen is utilized for generating a sense voltage Vsen based on a current flowing through the sixth transistor 435. The sense voltage Vsen is furnished to the control end of the second transistor 431. Accordingly, the second transistor 431 is utilized to control the first internal voltage Vint1 based on the sense voltage Vsen received by the control end.

The second voltage-dividing unit 475 comprises two voltage-dividing resistors Rdiv1, Rdiv2 and functions to provide a second divided voltage Vdiv2 of the first internal voltage Vint1 furnished to the third transistor 461 and the fourth transistor 463. The third transistor 461 comprises a first end for receiving a power voltage Vdd, a control end coupled to the second voltage-dividing unit 475 for receiving a second divided voltage Vdiv2, and a second end for outputting a second internal voltage Vint2. In one embodiment, the power voltage Vdd is the input voltage Vin. The fourth transistor 463 comprises a first end coupled to the second end of the third transistor 461, a second end coupled to the ground, and a control end coupled to the control end of the third transistor 461. The third transistor 461 and the fourth transistor 463 are coupled to form an inverter for performing an inverting operation on the second divided voltage Vdiv2 so as to generate the second internal voltage Vint2.

The fifth transistor 533 comprises a first end for receiving the power voltage Vdd, a second end coupled to the control end of the first transistor 415, and a control end coupled to the second end of the third transistor 461 for receiving the second internal voltage Vint2. As aforementioned, the power voltage Vdd can be the input voltage Vin. The sixth transistor 435 comprises a first end coupled to the sensing resistor Rsen, a second end coupled to the second end of the first transistor 415, and a control end coupled to the control end of the first transistor 415. The first transistor 415 and the sixth transistor 435 are coupled to form a current mirror, and therefore the current flowing through the sensing resistor Rsen is proportional to the output current Iout. Since the channel width/length ratio of the first transistor 415 is much greater than that of the sixth transistor 435, the current flowing through the sensing resistor Rsen is substantially much smaller than the output current Iout. The error amplifier 410 comprises a positive input end coupled to the first voltage-dividing unit 470 for receiving the first divided voltage Vdiv1, a negative input end for receiving a reference voltage Vref, and an output end coupled to the control end of the first transistor 415. The error amplifier 410 performs an error amplification operation on the first divided voltage Vdiv1 based on the reference voltage Vref for generating the current control signal Sct forwarded to the control end of the first transistor 415.

In the operation of the low dropout regulator 400, the first voltage-dividing unit 470 and the error amplifier 410 are employed to provide a negative feedback mechanism for controlling the first transistor 415 so as to stabilize the output voltage Vout. Besides, the sensing resistor Rsen, the second voltage-dividing unit 475, the second transistor 431, the third transistor 461, the fourth transistor 463, the fifth transistor 433 and the sixth transistor 435 are employed to provide a current-limiting mechanism for controlling the first transistor 415 so as to limit the output current Iout to be lower than an upper-limit current. The circuit operation of the low dropout regulator 400 is detailed as the followings.

When the output current Iout is less than the upper-limit current, the second transistor 431 is turned off by the sense voltage Vsen, and therefore both the first internal voltage Vint1 and the second divided voltage Vdiv2 are pulled down to ground voltage level; in turn, the third transistor 461 is turned on for pulling up the second internal voltage Vint2 to the power voltage Vdd so as to turn off the fifth transistor 433. Under such situation, the error amplifier 410 is utilized to adjust the voltage of the current control signal Sct by performing an error amplification operation on the first divided voltage Vdiv1; meanwhile, the first transistor 415 is used to control the output current Iout according to the current control signal Sct adjusted, and therefore controls the output voltage Vout. The circuit operation of the negative feedback mechanism, regarding the error amplifier 410 and the first voltage-dividing unit 470, is well known to those skilled in the art, and for the sake of brevity, further discussion thereof is omitted.

When the output current Iout is greater than the upper-limit current, the second transistor 431 is turned on by the sense voltage Vsen, and therefore the first internal voltage Vint1 is switched to be a high-level voltage; in turn, the second divided voltage Vdiv2 is pulled up for turning on the fourth transistor 463. When the fourth transistor 463 is turned on, the second internal voltage Vint2 is pulled down to ground voltage level for turning on the fifth transistor 433. Under such situation, the current control signal Sct is pulled up to the power voltage Vdd; meanwhile, the first transistor 415 is able to reduce the output current Iout to be less than the upper-limit current based on the current control signal Sct having the power voltage Vdd. In other words, when the output current Iout is greater than the upper-limit current, the voltage of the current control signal Sct cannot be adjusted by the error amplifier 410.

To sum up, in the operation of the low dropout regulator 400, the voltage drop across the sensing resistor Rsen is excluded from the voltage difference between the input voltage Vin and the output voltage Vout so that the voltage difference between the input and output voltages can be lessened. Furthermore, the current flowing through the sensing resistor Rsen is much smaller than the output current Iout, and therefore both the internal power consumption and the chip temperature can be reduced for improving circuit working efficiency. Besides, compared with the prior-art low dropout regulator 100, the comparator 120 and the reference current source 190 are not required in the low dropout regulator 400, and for that reason, the chip area can be reduced significantly for achieving low production cost.

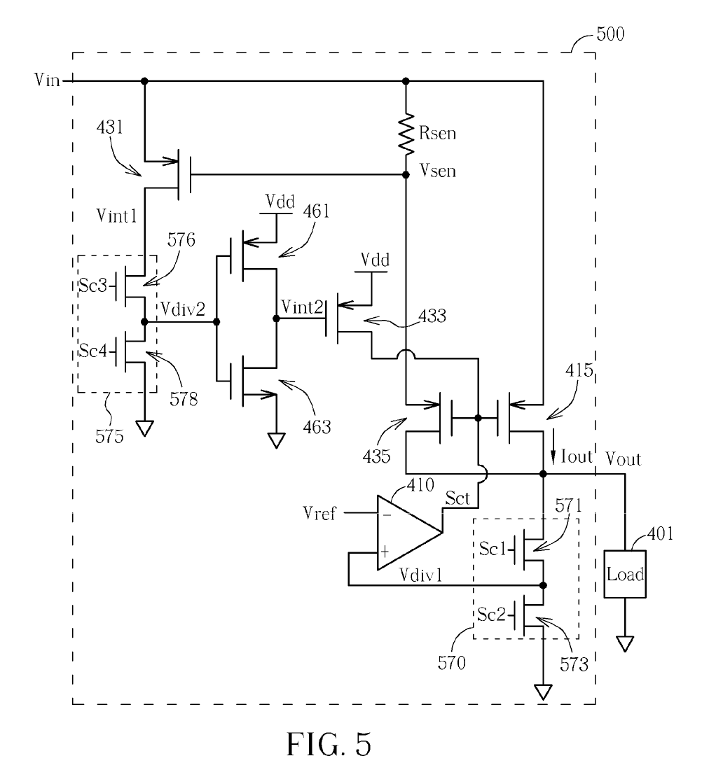

Please refer to FIG. 5, which is a circuit diagram schematically showing a low dropout regulator in accordance with a fourth embodiment of the present invention. As shown in FIG. 5, the circuit structure of the low dropout regulator 500 is similar to that of the low dropout regulator 400, differing in that the first voltage-dividing unit 470 is replaced with a first voltage-dividing unit 570 and the second voltage-dividing unit 475 is replaced with a second voltage-dividing unit 575. The first voltage-dividing unit 570 comprises a seventh transistor 571 and an eighth transistor 573. The seventh transistor 571 comprises a first end coupled to the second end of the first transistor 415, a second end coupled to the positive input end of the error amplifier 410, and a control end for receiving a first control signal Sc1. The first control signal Sc1 is employed to adjust the first channel resistance of the seventh transistor 571. The eighth transistor 573 comprises a first end coupled to the second end of the seventh transistor 571, a second end coupled to the ground, and a control end for receiving a second control signal Sc2. The second control signal Sc2 is employed to adjust the second channel resistance of the eighth transistor 573. The seventh transistor 571 and the eighth transistor 573 are MOS field effect transistors or junction field effect transistors.

The second voltage-dividing unit 575 comprises a ninth transistor 576 and a tenth transistor 578. The ninth transistor 576 comprises a first end coupled to the second end of the second transistor 431, a second end coupled to the control end of the third transistor 461, and a control end for receiving a third control signal Sc3. The third control signal Sc3 is employed to adjust the third channel resistance of the ninth transistor 576. The tenth transistor 578 comprises a first end coupled to the second end of the ninth transistor 576, a second end coupled to the ground, and a control end for receiving a fourth control signal Sc4. The fourth control signal Sc4 is employed to adjust the fourth channel resistance of the tenth transistor 578. The ninth transistor 576 and the tenth transistor 578 are MOS field effect transistors or junction field effect transistors.

Basically, both the first voltage-dividing unit 570 and the second voltage-dividing unit 575 are adjustable voltage dividers. The first voltage-dividing unit 570 performs a voltage dividing operation on the output voltage Vout for generating the first divided voltage Vdiv1 according to the adjusted first and second channel resistances. The second voltage-dividing unit 575 performs a voltage dividing operation on the first internal voltage Vint1 for generating the second divided voltage Vdiv2 according to the adjusted third and fourth channel resistances.

In another embodiment, both the control ends of the seventh transistor 571 and the eighth transistor 573 are utilized for receiving same control signal; besides, the first channel resistance is determined by the channel width/length ratio of the seventh transistor 571 and the second channel resistance is determined by the channel width/length ratio of the eighth transistor 573. In other words, the dividing ratio of the first voltage-dividing unit 570 can be determined by the channel width/length ratios of the seventh transistor 571 and the eighth transistor 573. The channel width/length ratio of the seventh transistor 571 can be identical to or different from that of the eighth transistor 573. Similarly, both the control ends of the ninth transistor 576 and the tenth transistor 578 are utilized for receiving same control signal; besides, the third channel resistance is determined by the channel width/length ratio of the ninth transistor 576 and the fourth channel resistance is determined by the channel width/length ratio of the tenth transistor 578. In other words, the dividing ratio of the second voltage-dividing unit 575 can be determined by the channel width/length ratios of the ninth transistor 576 and the tenth transistor 578. The channel width/length ratio of the ninth transistor 576 can be identical to or different from that of the tenth transistor 578.

In summary, regarding the operation of the low dropout regulator of the present invention, the voltage drop across the sensing resistor is excluded from the voltage difference between the input and output voltages so that the voltage difference between the input and output voltages can be lessened. Furthermore, the current flowing through the sensing resistor is much smaller than the output current, and therefore both the internal power consumption and the chip temperature can be reduced for improving circuit working efficiency. Besides, compared with the prior-art low dropout regulator, the comparator and the reference current source are not required in the low dropout regulator of the present invention, and for that reason, the chip area can be reduced significantly for achieving low production cost.

The present invention is by no means limited to the embodiments as described above by referring to the accompanying drawings, which may be modified and altered in a variety of different ways without departing from the scope of the present invention. Thus, it should be understood by those skilled in the art that various modifications, combinations, sub-combinations and alternations might occur depending on design requirements and other factors insofar as they are within the scope of the appended claims or the equivalents thereof.

What is claimed is:

1. A low dropout regulator comprising:
a first transistor comprising a first end for receiving an input voltage, a second end for outputting an output voltage and an output current, and a control end for receiving a current control signal, the first transistor being employed to control the output current based on the current control signal;
a second transistor comprising a first end for receiving the input voltage, a second end for outputting an internal voltage, and a control end;
a sensing resistor, electrically coupled between the first end and the control end of the second transistor, for generating a sense voltage furnished to the control end of the second transistor;
a third transistor comprising a first end electrically coupled to the control end of the first transistor, a second end electrically coupled to a ground, and a control end for receiving a divided voltage of the internal voltage;
a fourth transistor comprising a first end electrically coupled to the sensing resistor, a second end electrically coupled to the second end of the first transistor, and a control end electrically coupled to the control end of the first transistor; and
an error amplifier comprising a positive input end for receiving a reference voltage, a negative input end for receiving a divided voltage of the output voltage, and an output end electrically coupled to the control end of the first transistor, the error amplifier being employed to generate the current control signal based on the reference voltage and the divided voltage of the output voltage.

2. The low dropout regulator of claim 1, wherein the first transistor, the third transistor and the fourth transistor are N-type metal oxide semiconductor (MOS) field effect transistors or N-type junction field effect transistors.

3. The low dropout regulator of claim 2, wherein a channel width/length ratio of the first transistor is greater than a channel width/length ratio of the fourth transistor.

4. The low dropout regulator of claim 1, wherein the second transistor is a P-type MOS field effect transistor or a P-type junction field effect transistor.

5. The low dropout regulator of claim 1, further comprising a voltage-dividing unit, the voltage-dividing unit comprising:
a first resistor electrically coupled between the second end of the first transistor and the negative input end of the error amplifier; and
a second resistor electrically coupled between the negative input end of the error amplifier and the ground.

6. The low dropout regulator of claim 1, further comprising a voltage-dividing unit, the voltage-dividing unit comprising:
a fifth transistor comprising a first end electrically coupled to the second end of the first transistor, a second end electrically coupled to the negative input end of the error amplifier, and a control end for receiving a first control signal; and
a sixth transistor comprising a first end electrically coupled to the second end of the fifth transistor, a second end electrically coupled to the ground, and a control end for receiving a second control signal.

7. The low dropout regulator of claim 6, wherein the fifth transistor and the sixth transistor are MOS field effect transistors or junction field effect transistors, and a channel width/length ratio of the fifth transistor is identical to or different from a channel width/length ratio of the sixth transistor.

8. The low dropout regulator of claim 1, further comprising a voltage-dividing unit, the voltage-dividing unit comprising:
a first resistor electrically coupled between the second end of the second transistor and the control end of the third transistor; and
a second resistor electrically coupled between the control end of the third transistor and the ground.

9. The low dropout regulator of claim 1, further comprising a voltage-dividing unit, the voltage-dividing unit comprising:
a fifth transistor comprising a first end electrically coupled to the second end of the second transistor, a second end electrically coupled to the control end of the third transistor, and a control end for receiving a first control signal; and
a sixth transistor comprising a first end electrically coupled to the second end of the fifth transistor, a second end electrically coupled to the ground, and a control end for receiving a second control signal.

10. The low dropout regulator of claim 9, wherein the fifth transistor and the sixth transistor are MOS field effect transistors or junction field effect transistors, and a channel width/length ratio of the fifth transistor is identical to or different from a channel width/length ratio of the sixth transistor.

11. A low dropout regulator comprising:
a first transistor comprising a first end for receiving an input voltage, a second end for outputting an output voltage and an output current, and a control end for receiving a current control signal, the first transistor being employed to control the output current based on the current control signal;
a second transistor comprising a first end for receiving the input voltage, a second end for outputting an internal voltage, and a control end;
a sensing resistor, electrically coupled between the first end and the control end of the second transistor, for generating a sense voltage furnished to the control end of the second transistor;
a third transistor comprising a first end for receiving a power voltage or the input voltage, a second end, and a control end for receiving a divided voltage of the internal voltage;
a fourth transistor comprising a first end electrically coupled to the second end of the third transistor, a second end electrically coupled to a ground, and a control end electrically coupled to the control end of the third transistor;
a fifth transistor comprising a first end for receiving the power voltage or the input voltage, a second end electrically coupled to the control end of the first transistor, and a control end electrically coupled to the second end of the third transistor;
a sixth transistor comprising a first end electrically coupled to the sensing resistor, a second end electrically coupled to the second end of the first transistor, and a control end electrically coupled to the control end of the first transistor; and
an error amplifier comprising a positive input end for receiving a divided voltage of the output voltage, a negative input end for receiving a reference voltage, and an output end electrically coupled to the control end of the first transistor, the error amplifier being employed to generate the current control signal based on the reference voltage and the divided voltage of the output voltage.

12. The low dropout regulator of claim 11, wherein the first transistor, the second transistor, the third transistor, the fifth transistor and the sixth transistor are P-type MOS field effect transistors or P-type junction field effect transistors.

13. The low dropout regulator of claim 12, wherein a channel width/length ratio of the first transistor is greater than a channel width/length ratio of the sixth transistor.

14. The low dropout regulator of claim 11, wherein the fourth transistor is an N-type MOS field effect transistor or an N-type junction field effect transistor.

15. The low dropout regulator of claim 11, further comprising a voltage-dividing unit, the voltage-dividing unit comprising:
a first resistor electrically coupled between the second end of the first transistor and the positive input end of the error amplifier; and
a second resistor electrically coupled between the positive input end of the error amplifier and the ground.

16. The low dropout regulator of claim 11, further comprising a voltage-dividing unit, the voltage-dividing unit comprising:
a seventh transistor comprising a first end electrically coupled to the second end of the first transistor, a second end electrically coupled to the positive input end of the error amplifier, and a control end for receiving a first control signal; and
an eighth transistor comprising a first end electrically coupled to the second end of the seventh transistor, a second end electrically coupled to the ground, and a control end for receiving a second control signal.

17. The low dropout regulator of claim 16, wherein the seventh transistor and the eighth transistor are MOS field effect transistors or junction field effect transistors, and a channel width/length ratio of the seventh transistor is identical to or different from a channel width/length ratio of the eighth transistor.

18. The low dropout regulator of claim 11, further comprising a voltage-dividing unit, the voltage-dividing unit comprising:
a first resistor electrically coupled between the second end of the second transistor and the control end of the third transistor; and
a second resistor electrically coupled between the control end of the third transistor and the ground.

19. The low dropout regulator of claim 11, further comprising a voltage-dividing unit, the voltage-dividing unit comprising:
a seventh transistor comprising a first end electrically coupled to the second end of the second transistor, a second end electrically coupled to the control end of the third transistor, and a control end for receiving a first control signal; and
an eighth transistor comprising a first end electrically coupled to the second end of the seventh transistor, a second end electrically coupled to the ground, and a control end for receiving a second control signal.

20. The low dropout regulator of claim 19, wherein the seventh transistor and the eighth transistor are MOS field effect transistors or junction field effect transistors, and a channel width/length ratio of the seventh transistor is identical to or different from a channel width/length ratio of the eighth transistor.
